(19) United States
(12) Patent Application Publication
(10) Pub. No.: US 2006/0115145 A1
(43) Pub. Date: Jun. 1, 2006

(54) Bayesian conditional random fields

(75) Inventors: Christopher Bishop, Cambridge (GB); Martin Szummer, Cambridge (GB); Tonatiuh Pena Centeno, Sheffield (GB); Markus Svensen, Cambridge (GB); Yuan Qi, Cambridge, MA (US)

Correspondence Address: Microsoft Corporation;c/o Carole Boelitz, One Microsoft Way, Redmond, WA, 98052, US

(73) Assignee: Microsoft Corporation, Redmond, WA (US)

(21) Appl. No.: 10/999,880

(22) Filed: Nov. 30, 2004

(51) Int. Cl. G06K 9/62

(52) U.S. Cl. 382/155

(57) ABSTRACT

A Bayesian approach to training in conditional random fields takes a prior distribution over the modeling parameters of interest. These prior distributions may be used to generate an approximate form of a posterior distribution over the parameters, which may be trained with example or training data. Automatic relevance determination (ARD) may be integrated in the training to automatically select relevant features of the training data. From the trained posterior distribution of the parameters, a posterior distribution over the parameters based on the training data and the prior distributions over parameters may be approximated to form a training model. Using the developed training model, a given image may be evaluated by integrating over the posterior distribution over parameters to obtain a marginal probability distribution over the labels given that observational data.

### TECHNICAL FIELD

The present application relates to machine learning, and more specifically, to learning with Bayesian conditional random fields.

### BACKGROUND

Markov random fields (“MRFs”) have been widely used to model spatial distributions such as those arising in image analysis. For example, patches or fragments of an image may be labeled with a label y based on the observed data x of the patch. MRFs model the joint distribution, i.e., p(y,x), over both the observed image data x and the image fragment labels y. However, if the ultimate goal is to obtain the conditional distribution of the image fragment labels given the observed image data, i.e., p(y|x), then conditional random fields (“CRFs”) may model the conditional distribution directly. Conditional on the observed data x, the distribution of the labels y may be described by an undirected graph. From the Hammersley-Clifford Theorem and provided that the conditional probability of the labels y given the observed data x is greater than 0, then the distribution of the probability of the labels given the observed data may factorize according to the following equation:

$$p ( y \vert x ) = \frac{1}{Z ( x )} {\prod }_{c} {Ψ}_{c} ( {y}_{c} , x ) \qquad ( 1 )$$

The product of the above equation runs over all connected subsets c of nodes in the graph, with corresponding label variables denoted y_{c}, and a normalization constant denoted Z(x) which is often called the partition function. In many instances, it may be intractable to evaluate the partition function Z(x) since it involves a summation over all possible states of the labels y. To make the partition function tractable, learning in conditional random fields has typically been based on a maximum likelihood approximation.

### SUMMARY

The following presents a simplified summary of the disclosure in order to provide a basic understanding to the reader. This summary is not an exhaustive or limiting overview of the disclosure. The summary is not provided to identify key and/or critical elements of the invention, delineate the scope of the invention, or limit the scope of the invention in any way. Its sole purpose is to present some of the concepts disclosed in a simplified form, as an introduction to the more detailed description that is presented later.

Conditional random fields model the probability distribution over the labels given the observational data, but do not model the distribution over the different features or observed data. A Maximum Likelihood implementation of a conditional random field provides a single solution, or a unique parameter value that best explains the observed data. On the other hand, the single solution of Maximum Likelihood algorithms may have singularities, i.e., the probability may be infinite, and/or the data may be over-fit such as by modeling not only the transient data but also particularities of the training set data.

A Bayesian approach to training in conditional random fields defines a prior distribution over the modeling parameters of interest. These prior distributions may be used in conjunction with the likelihood of given training data to generate an approximate posterior distribution over the parameters. Automatic relevance determination (ARD) may be integrated in the training to automatically select relevant features of the training data. The posterior distribution over the parameters based on the training data and the prior distributions over parameters form a training model. Using the developed training model, a given image may be evaluated by integrating over the posterior distribution over parameters to obtain a marginal probability distribution over the labels given that observational data.

More particularly, observed data, such as a digital image, may be fragmented to form a training data set of observational data. The fragments may be at least a portion of and possibly all of an image in the set of observational data. A neighborhood graph may be formed as a plurality of connected nodes, which each node representing a fragment. Relevant features of the training data may be detected and/or determined in each fragment. Local node features of a single node may be determined and interaction features of multiple nodes may be determined. Features of the observed data may be pixel values of the image, contrast between pixels, brightness of the pixels, edge detection in the image, direction/orientation of the feature, length of the feature, distance/relative orientation of the feature relative to another feature, and the like. The relevance of features of an image fragment may be automatically determined through automatic relevance determination (ARD).

The labels associated with each fragment node of the training data set are known, and presented to a training engine with the associated training data set of the training images. Using a Bayesian conditional random field, the training engine may develop a posterior probability of modeling parameters, which may be used to develop a training model to determine a posterior probability of the labels y given the observed data set x. The training model may be used to predict a label probability distribution for a fragment of the observed data xᵢ in a test image to be labeled.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an example computing system for implementing a labeling system of FIG. 2;

FIG. 2 is a dataflow diagram of an example labeling system for implementing Bayesian Conditional Random Fields;

FIG. 3 is a flow chart of an example method of implementing Bayesian Conditional Random Fields of FIG. 2;

FIG. 4 is a flow chart of an example method of training Bayesian Conditional Random Fields of FIG. 3 using variational inference;

FIG. 5 is a flow chart of an example method of training Bayesian Conditional Random Fields of FIG. 3 using expectation propagation;

FIG. 6 is a flow chart of an example method of predicting labels using Bayesian Conditional Random Fields of FIG. 3 using iterated conditional modes; and

FIG. 7 is a flow chart of another example method of predicting labels using Bayesian Conditional Random Fields of FIG. 3 using loopy max product.

### DETAILED DESCRIPTION

Exemplary Operating Environment

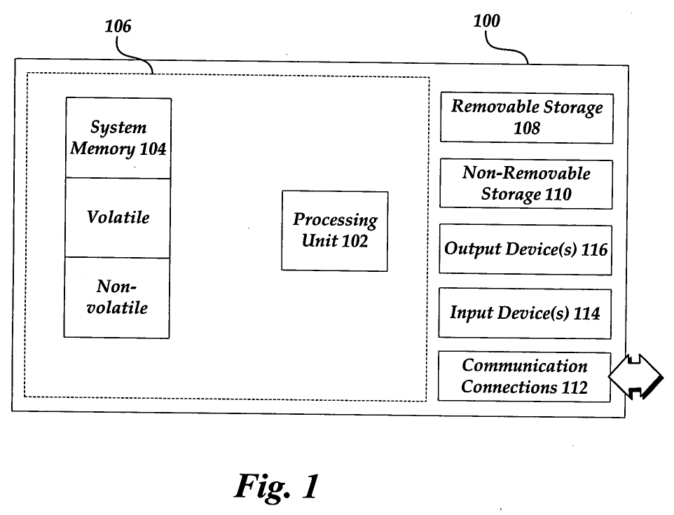

FIG. 1 and the following discussion are intended to provide a brief, general description of a suitable computing environment in which a labeling system using Bayesian conditional random fields may be implemented. The operating environment of FIG. 1 is only one example of a suitable operating environment and is not intended to suggest any limitation as to the scope of use or functionality of the operating environment. Other well known computing systems, environments, and/or configurations that may be suitable for use with a labeling system using Bayesian conditional random fields described herein include, but are not limited to, personal computers, server computers, hand-held or laptop devices, multiprocessor systems, micro-processor based systems, programmable consumer electronics, network personal computers, mini computers, mainframe computers, distributed computing environments that include any of the above systems or devices, and the like.

Although not required, the labeling system using Bayesian conditional random fields will be described in the general context of computer-executable instructions, such as program modules, being executed by one or more computers or other devices. Generally, program modules include routines, programs, objects, components, data structures, etc., that perform particular tasks or implement particular abstract data types. Typically, the functionality of the program modules may be combined or distributed as desired in various environments.

With reference to FIG. 1, an exemplary system for implementing the labeling system using Bayesian conditional random fields includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features and/or functionality. For example, device 100 may also include additional storage (e.g., removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules, or other data. Memory 104, removable storage 108, and non-removable storage 110 are all examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communication connection(s) 112 that allow the device 100 to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes both storage media and communication media.

Device 100 may also have input device(s) 114 such as keyboard, mouse, pen, voice input device, touch input device, and/or any other input device. Output device(s) 116 such as display, speakers, printer, and/or any other output device may also be included.

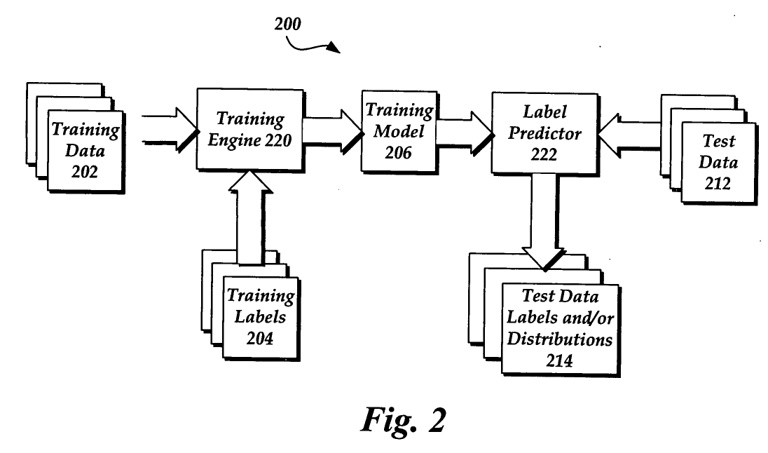

FIG. 2 illustrates a labeling system 200 for implementing Bayesian conditional random fields within the computing environment of FIG. 1. Labeling system 200 comprises a training engine 220 and a label predictor 222. The training engine 220 may receive training data 202 and their corresponding training labels 204 to generate a training model 206. A label predictor 222 may use the generated training model 206 to predict test data labels 214 for observed test data 212. Although FIG. 2 shows the training engine 220 and the label predictor 222 in the same labeling system 200, they may be supported by separate computing devices 100 of FIG. 1.

The training data 202 may be one or more digital images, and each training image may be fragmented into one or more fragments or patches. The training labels 204 identify the appropriate label or descriptor for each training image fragment in the training data 202. The available training labels identify the class or category of a fragment or a group of fragments. For example, the training data may include digital images of objects alone, in context, and/or in combination with other objects, and the associated labels 204 may identify particular fragments of the images, such as each object in the image, as man-made or natural, e.g., a tree may be natural and a farm house may be man-made. It is to be appreciated that any type of data having a suitable amount of spatial structure and/or label may be used as training data 202 and/or training label 204 as appropriate for the resulting training model 206 which may be used to predict label distributions 214 for test data 212. Other examples of suitable training data may include a set of digital ink strokes or drawing forming text and/or drawings, images of faces, images of vehicles, text, and the like. An image of digital ink strokes may include the stroke information captured by the pen tablet software or hardware. The labels associated with the data may be any suitable labels to be associated with the data, and may include, without limitation, character text and/or symbol identifiers, organization chart box and/or connector identifiers, friend and foe identifiers, object identifiers, and the like. The test data 212 may be of the same type of image or different type of image than the training data 202, however, the test data labels 214 are selected from the available training labels 204. Although the following description is made with reference to test images illustrating objects which may be labeled man-made or natural, it is to be appreciated that the test data and/or associated labels for the test data may be any suitable data and/or label as appropriate, and that the labels may include two or more labels.

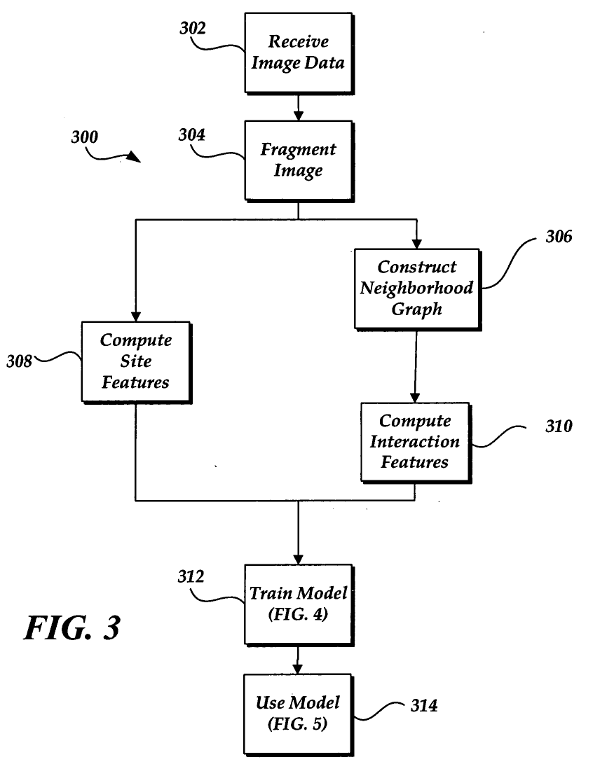

One example method 300 of generating and using the training model 206 of FIG. 2 is illustrated in FIG. 3 with reference to the example labeling system of FIG. 2. Initially, the training data 202 may be received 302, such as by the training engine 220. The training data may be formatted and/or modified as appropriate for use by the training engine. For example, a drawing may be digitized.

The training data 202 may be fragmented 304 using any suitable method, which may be application specific. For example, with respect to digital ink, the ink strokes may be divided into simpler components based on line segments which may be straight to within a given tolerance, single dots of ink, pixels, arcs or other objects. In one example, the choice of fragments as approximately straight line segments may be selected by applying a recursive algorithm which may break a stroke at the point of maximum deviation from a straight line between the end-points, and may stop recursing and form a fragment when the deviation is less than some tolerance. Another example of image fragments may be spatially distributed patches of the image, which may be co-extensive or spaced. Moreover, the image fragments may be of the same shape and/or size, or may differ as suitable to the fragments selected.

Based upon the fragments of each training image, a neighborhood, undirected graph for each image maybe constructed 306 using any suitable method. In some cases, the graphs of several images may have the same or similar structure; however, each graph associated with each image is independent of the graphs of the other images in the training data. For example, a node for each fragment of the training image may be constructed, and edges added between the nodes whose relation is to be modeled in the training model 206. Example criteria for edge creation between nodes may include connecting a node to a predetermined number of neighboring nodes based on shortest spatial distance, co-extensive edges or vertices of image fragments, and the like; connecting a node to other nodes lying within a predetermined distance; and/or connecting a node to all other nodes; and the like. In this manner, each node may indicate a fragment to be classified by the labels y, and the edges between nodes may indicate dependencies between the labels of pairwise nodes connected by an edge.

A clique may be defined as a set of nodes which form a subgraph that is complete, i.e., fully connected by edges, and maximal, i.e., no more nodes can be added without losing completeness. For example, a clique may not exist as a subset of another clique. In an acyclic graph (i.e., a tree), the cliques may comprise the pairs of nodes connected by edges, and any individual isolated nodes not connected to anything.

In some cases, the neighborhood graph may be triangulated. For example, edges may be added to the graph such that every cycle of length more than three has a chord. Triangulation is discussed further in Castillo et al., “Expert Systems and Probabilistic Network Models,” 1997, Springer, ISBN: 0-387-94858-9 which is incorporated by reference herein.

In conditional random fields, each label yᵢ is conditioned on the whole of the observation data x. The global conditioning of the labels allows flexible features that may capture long-distance dependencies between nodes, arbitrary correlation, and any suitable aspect of the image data.

One or more site features of each node of the test data 202 may be computed 308. Features of the node may be one or more characteristics for the test data fragment that distinguish the fragments from each other and/or discriminate between the available labels for each fragment. The site features may be based on observations in a local neighborhood, or alternatively may be dependent on global properties of all observed image data x. For example, the site features of an image may include pixel values of the image fragment, contrast values of the image fragment, brightness of the image fragment, detected edges in the fragment, direction/orientation of the feature, length of the feature, and the like.

In one example, the site features may be computed with a site feature function. Site features which are local independent features may be indicated as a fixed, non-linear function dependent on the test image data x, and may be indicated as a site function vector hᵢ(x), where i indicates the node. The site feature function may be applied to the training data x to determine the feature(s) of a fragment i. A site feature function h may be chosen for each node to determine features which help determine the label y for that fragment, e.g., edges in the image may indicate a man-made or natural object.

One or more interaction features of each connection edge of the graph between pairwise nodes of the test data 202 may be computed 310. Interaction features of an edge may be one or more characteristics based on both nodes and/or global properties of the observed data x. The interaction features may indicate a correlation between the labels for the pairwise nodes. For example, the interaction feature of an image may include relative pixel values, relative contrast values, relative brightness, distance/relative orientation of a site feature of one node relative to another site feature of another pairwise node, connection and/or continuation of a site feature of one node to a pairwise node, relative temporal creation of a site feature of a node relative to another pairwise node, and the like. The site and/or interaction features may be at least a portion of the test data image or may be function of the test data.

In one example, the interaction features may be computed with an interaction feature function. Interaction features between a pair of nodes may be indicated as a fixed, non-linear function dependent on the test image data x, and may be indicated as an interaction function vector μᵢⱼ(x), where i and j indicate the nodes being paired. The interaction feature function may be applied to the training image data x to determine the feature(s) of an edge connecting the pairwise nodes. Although the description below is directed to pairing two nodes (i.e., i and j), it is to be appreciated that two or more nodes may be paired or connected to indicate interaction between the nodes. An interaction feature function μ may be chosen for each edge of the graph connecting nodes i and j to determine features which help determine the label y for that pairwise connection may extend from one fragment to another which may lead to a strong correlation between the labels of the nodes; and/or neighboring nodes having similar site features, then their labels may also be similar.

The h and μ functions may be any appropriate function of the training data and the training data. For example, the intensity gradient may be computed at each pixel in each fragment. These gradient values may be accumulated into a weighted histogram. The histogram may be smoothed, and a number of top peaks may be determined, such as the top two peaks. The location of the top peak and the difference to the second top peak, both being angles measured in radians, may become elements of the site feature function h. More particularly, this may find the dominant edges in a fragment. If these edges are nearly horizontal or nearly vertical and/or roughly square angles to each other in the fragment, then these features may be indicative of a man-made object in the fragment. The interaction feature function μ may be a concatenation of the site features of the pairwise nodes i and j. This may reveal whether or not the pairwise nodes exhibit the same direction in their dominant edges, such as arising from an edge of a roof that extends over multiple fragments. If either the function h or the function μ is linear, an arbitrary non-linearity may be added. Since the local feature vector function hᵢ and pairwise feature vector function μᵢⱼ may be fixed, i.e., the functions may not depend on any other parameters other than the observed image data x, the parameterized models of the association potential and the interaction potential may be restricted to a linear combination of fixed basis functions.

In one example, a site feature function may be selected as part of the learning process and a training model may be determined and tested to determine if the selected function is appropriate. In another example, the candidate set of functions may be a set of different types of edge detectors which have different scales, different orientation, and the like; in this manner, the scale/orientation may help select a suitable site feature function. Alternatively, heuristics or any other appropriate method may be used to select the appropriate site feature function h and/or the interaction feature function μ. As noted above, each element of the site feature function vector and h and the interaction feature function vector μ represents a particular function, which may be the same as or different from other functions with each function vector. Automatic relevance detection, as discussed further below, may be used to select the elements of the site feature function h and/or the interaction feature function μ from a candidate set of feature functions which are relevant to training the training model.

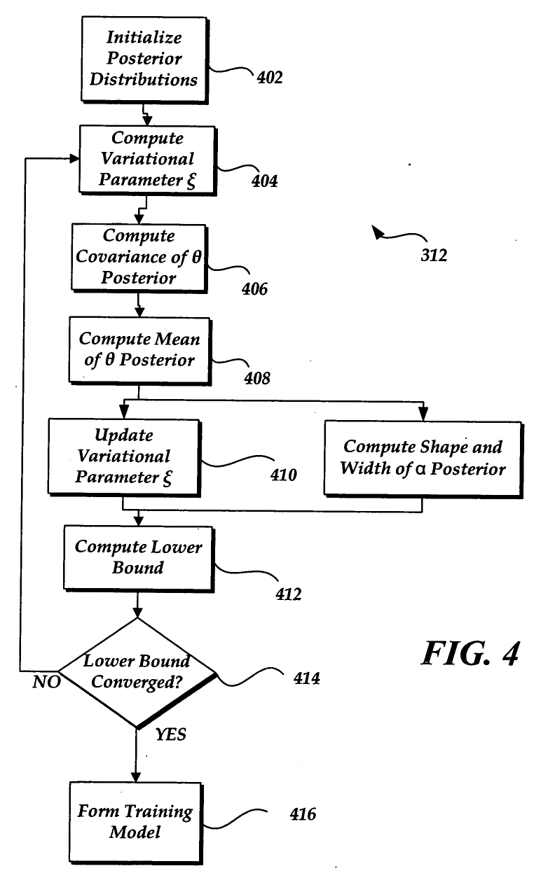

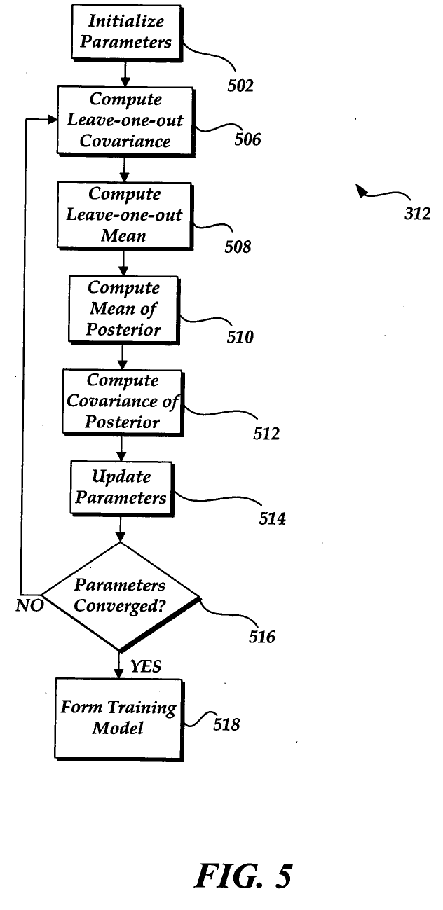

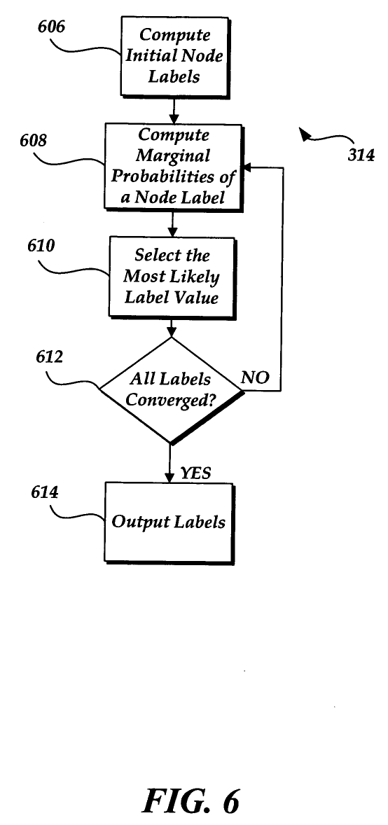

The determined site features hᵢ(x) of each node i and the determined interaction features μᵢⱼ(x) of each edge connecting nodes i and j may be used to train 312 the training model 206 if the image data is training data 202 and the training labels 204 are known for each node. If the labels for the features of each are not known, then a developed training model may be used 314 to generate label probability distributions for the nodes of the test image data. Training 312 the training model is described further with reference to FIGS. 4 and 5, and using 314 the training model is described further with reference to FIG. 6.

The site features may be used to apply a classifier independently to each node i and assign a label probability. In a conditional random field with no interactions between the nodes, the conditional label probability may be developed using the following equation:

$${p}_{i} \text{(} {y}_{i} \vert x , w ) = \frac{1}{Z ( w )} Ψ ( {y}_{i} {w}^{T} {h}_{i} ( x ) ) \qquad ( 2 )$$

Here the site feature vector hᵢ is weighted by the site modeling parameter vector w, and then fed through a non-linearity function Ψ and normalized to sum to 1 with a partition function Z(w). The non-linearity function Ψ may be any appropriate function such as an exponential to obtain a logistic classifier, a probit function which is the cumulative distribution of a Gaussian, and the like.

However, image fragments may be similar to one another, and accordingly, contextual information may be used, i.e., the edges indicating a correlation or dependency between the labels of pairwise nodes may be considered. For example, if a first node has a particular label, a neighboring node and/or node which contains a continuation of a feature from the first node may have the same label as the first node. In this manner, the spatial relationships of the nodes may be captured. To capture the spatial relationships, a joint probabilistic model may be used so the grouping and label of one node may be dependent on the grouping and labeling of the rest of the graph.

The Hammersley-Clifford theorem shows that the conditional random field conditional distribution p(y|x) can be written as a normalized product of potential functions on complete sub-graphs of the graph of nodes. To capture the pairwise dependencies along with the independent site classification, two types of potentials may be used: a site association potential A(yᵢ,x;w) which measures the compatibility of a label with the image fragment, and an interaction potential I(yᵢⱼ,x;v) which measures the compatibility between labels of pairwise nodes. The interaction modeling parameter vector v, like the site modeling parameter vector w, weights the observed image data x, i.e., the interaction feature vector μᵢⱼ(x). A high positive value for wᵢ or vᵢ may indicate that the associated feature (site feature hᵢ or interaction feature μᵢ, respectively) has a high positive influence. Conversely, a value of zero for wᵢ or vᵢ may indicate that the associated feature site feature hᵢ or interaction feature μᵢ is irrelevant to the site association or interaction potential, respectively.

An association potential A for a particular node may be constructed based on the label for a particular node, image data x of the entire image, and the site modeling parameter vector w. The association potential may be indicated as A(yᵢ,x) where yᵢ is the label for a particular node i and x is the training image data. In this manner, the association potential may model the label for one fragment based upon the features for all fragments.

An interaction potential may be constructed based on the labels of two or more associated nodes and image data for the entire image. Although the following description is with reference to interaction potentials based on two pairwise nodes, however, it is to be appreciated that two or more nodes may be used as a basis for the interaction potential, although there may be an increase in complexity of the notation and computation. The interaction potential I may be indicated as I(yᵢ,yⱼ,x) where yᵢ is the label for a first node i, yⱼ is the label for a second node j, and x is the training data. In some cases, it may appropriate to assume that the model is homogeneous and isotropic, i.e., that the association potential and the interaction potential are taken to be independent of the indices i and j.

A functional form of conditional random fields may use the site association potential and the interaction potential to determine the conditional probability of a label given observed image data p(y|x). For example, the conditional distribution of the labels given the observed data may be written as:

$$p \text{(} y \vert x ) = \frac{1}{Z ( w , v , x )} ( {\prod }_{i} A ( {y}_{i} , x ) {\prod }_{i} {\prod }_{j} I ( {y}_{i} , {y}_{j} , x ) ) \qquad ( 3 )$$

where the parameter i indicates each node, and the parameter j indicates the pairwise or connected hidden node indices corresponding to the paired nodes of i and j in the undirected graph. The function Z is a normalization constant known as the partition function, similar to that described above.

The site association and interaction potentials may be parameterized with the weighting parameters w and v discussed above. The site association potential may be parameterized as a function:
A(yᵢ,x)=Ψ(yᵢw^{T}hᵢ(x)) (4)
where hᵢ(x) is a vector of features determined by the function h based on the training image data x. The basis or site feature function h may allow the classification boundary to be non-linear in the original features. The parameter yᵢ is the known training label for the node i, and w is the site modeling parameter vector. As in generalized linear models, the function Ψ can be a logistic function, a probit function, or any suitable function. In one example, the non-linear function Ψ may be constructed as a logistic function leading to a site association potential of:
A(yᵢ,x)=exp[1nσ(yᵢw^{T}hᵢ(x))] (5)
where σ(.) is a logistic sigmoid function, and the site modeling parameter vector w is an adjustable parameter of the model to be determined during learning. The logistic sigmoid function σ is defined by:

$$σ ( a ) = \frac{1}{1 + exp ( - a )} \qquad ( 6 )$$

The interaction potential may be parameterized as a function:
I(y_{i,} y_{j,} x)=exp[yᵢyⱼv^{T}μᵢⱼ(x)] (7)

Where μᵢⱼ(x) is a vector of features determined by the interaction function based on the training image data x; yᵢ is the known training label for the node i; yⱼ is the known training label for the node j; and the interaction modeling parameter vector v is an adjustable parameter of the model to be determined in training.

In some cases, it may be appropriate to define the site association potential A and/or to the interaction potential I to admit the possibility of errors in labels and/or measurements. Accordingly, a labeling error rate ε may be included in the site association potential and/or the interaction potential I. In this manner, the site association potential may be constructed as:
A(yᵢ,x)=(1−ε)Ψ_{τ}(yᵢw^{T}hᵢ(x))+ε(1−Ψ_{τ}(yᵢw^{T}hᵢ(x))) (8)
where w is the site modeling parameter vector, and Ψ_{τ}(y) is the cumulative distribution for a Gaussian with mean of zero and a variance of τ². The parameter ε is the labeling error rate and h(x) is the feature extracted at site i of the conditional random field. In some cases, it may be appropriate to place no restrictions on the relation between features hᵢ(x) and hⱼ(x) at different sites i and j. For example, features can overlap nodes and be strongly correlated.

Similarly, a labeling error rate may be added to the interaction potential I, and constructed as:
I((y_{i,} yⱼ,x)=(1−ε)Ψ_{τ}(yᵢ yⱼv^{T}μᵢⱼ(x))+ε(1−Ψ_{τ}(yᵢyⱼv^{T}μᵢⱼ(x))) (9)

The parameterized models may be described with reference to a two-state model, for which the two available labels y₁ and y₂ for a fragment may be indicated in binary form, i.e., the label y is an either 1 or −1. The exponential of a linear function of yᵢ being 1 or −1 is equivalent to the logistic sigmoid of that function. In this manner, the conditional random field model for the distribution of the labels given observation data may be simplified and have explicit dependencies on the parameters w and v as shown:

$$p \text{(} y \vert x , w , v ) = \frac{1}{\tilde{Z} ( w , v , x )} exp ( {\sum }_{i} {y}_{i} {w}^{T} {h}_{i} ( x ) / 2 + {\sum }_{i} {\sum }_{j} {y}_{i} {y}_{j} {v}^{T} {μ}_{ij} ( x ) ) \qquad ( 10 )$$

The partition function \tilde{Z} may be defined by:

$$\tilde{Z} ( w , v , x ) = {\sum }_{y} exp ( {\sum }_{i} {y}_{i} {w}^{T} {h}_{i} ( x ) / 2 + {\sum }_{i , j} {y}_{i} {y}_{j} {v}^{T} {μ}_{ij} ( x ) ) \qquad ( 11 )$$

This model can be extended to situations with more than two labels by replacing the logistic sigmoid function with a softmax function as follows. First, a set of probabilities using the softmax may be defined as follows:

$$p ( k ) = \frac{exp ( {w}_{k}^{T} {h}_{k} ( x ) )}{{\sum }_{j} exp ( {w}_{j}^{T} {h}_{j} ( x ) )}$$

where k labels the class. These may then be used to define the site and interaction potentials as follows:
A(yᵢ=k)=p(k)
I(yᵢ=k, yⱼ=l)=exp(v^{T}ₖₗμᵢⱼ)

A likelihood function may be maximized to determine the feature parameters w and v to develop a training model from the conditional probability function p(y|x,w,v). The likelihood function L(w,v) may be shown by:

$$L ( w , v ) = p ( Y \vert X , w , v ) = {\prod }_{n = 1}^{N} p ( {y}_{n} \vert {x}_{n} , w , v ) \qquad ( 12 )$$

where Y is a matrix whose nth row is given by the set of labels yₙ for the fragments of the observed training image xₙ. Analogously, X is a matrix whose nth row is given by the set of observed training image data xₙ for a particular image, with N images in the training data. However, the conditional probability function p(yₙ|xₙ, w,v) may be intractable since the partition function \tilde{Z} may be intractable. More particularly, the partition function \tilde{Z} is summed over all combinations of labels and image fragments. Accordingly, even with only two available labels, the partition function \tilde{Z} may become very large since it will be summed over two to the power of the number of fragments in the training data.

Accordingly, a pseudo-likelihood approximation may approximate the conditional probability p(y|x,w,v) and takes the form:

$$p ( y \vert x , w , v ) ≅ {\prod }_{i} p ( {y}_{i} \vert {y}_{{E}_{l}} , x , w , v ) \qquad ( 13 )$$

Where y_{Ei} denotes the set of label values yⱼ which are pairwise connected neighbors of node i in the undirected graph. In this manner the joint conditional probability distribution is approximated by the product of the conditional probability distributions at each node. The individual conditional distributions which make up the pseudo-likelihood approximation may be written using the feature parameter vectors w and v, which may be concatenated into a parameter vector θ. Moreover, the feature vector hᵢ(x) and μᵢⱼ(x) may be combined as a feature vector φᵢ where
φ(y_{Ei},x)=[hᵢ(x), 2Σyⱼμᵢⱼ(x)]. (14)

Since the site association and the interaction potentials are sigmoidal up to a scaling factor, the pseudo-likelihood function F(θ) may be written as a product of sigmoidal functions:

$$F ( θ ) = {\prod }_{n = 1 , i}^{N} σ ( {y}_{in} {θ}^{T} {ϕ}_{in} ) \qquad ( 15 )$$

Accordingly, learning algorithms may be applied to the pseudo-likelihood function to determine the posterior distributions of the parameter vectors w and v, which may be used to develop a prediction model of the conditional probability of the labels given a set of observed data.

Bayesian conditional random fields use the conditional random field defined by the neighborhood graph. However, Bayesian conditional random fields start by constructing a prior distribution of the weighting parameters, which is then combined with the likelihood of given training data to infer a posterior distribution over those parameters. This is opposed to non-Bayesian conditional random fields which infer a single setting of the parameters.

A Bayesian approach may be taken to compute the posterior of the parameter vectors w and v to train the conditional probability p(y|x,w,v). The computed posterior probabilities may then be used to formulate the site association potential and the interaction potential to calculate the posterior conditional probability of the labels, i.e., the prediction model. Mathematically, Bayes' rule states that the posterior probability that the label is a specific label given a set of observed data equals the conditional probability of the observed data given the label multiplied by the prior probability of the specific label divided by the marginal likelihood of that observed data.

Thus, under Bayes' rule, to compute the posterior of the parameter vectors w and v, i.e., θ, the independent prior of the parameter vector θ may be assigned conditioned on a value for a vector of modeling hyper-parameters α which may be defined by:

$$p ( θ \vert α ) = {\prod }_{j = 1}^{M} ℵ ( {θ}_{j} \vert 0 , {α}_{j}^{- 1} ) \qquad ( 16 )$$

Where [symbol] (θ|m,S) denotes a Gaussian distribution over θ with mean m and covariance S, α is the vector of hyper-parameters, and M is the number of parameters in the vector θ. A conjugate Gamma hyper-prior may be placed independently over each of the hyper-parameters αⱼ so that the probability of α may be shown as:

$$p ( α ) = {\prod }_{j = 1}^{M} G \text{(} {α}_{j} \vert {a}_{0} , {b}_{0} ) = {\prod }_{j = 1}^{M} \frac{1}{{Γ ( {a}_{0} )}_{}^{}} {b}_{0}^{{a}_{0}} {α}_{j}^{{a}_{0} - 1} {ⅇ}^{- {b}_{0} {α}_{j}} \qquad ( 17 )$$

where the values of a₀ and b₀ may be chosen to give broad hyper-prior distributions. This form of prior is one example of incorporating automatic relevance determination (ARD). More particularly, if the posterior distribution for a hyper-parameter αⱼ has most of its mass at large values, the corresponding parameter θⱼ is effectively pruned from the model. More particularly, features of the nodes and/or edges may be removed or effectively removed if, for example, the mean of their associated α parameter, given by the ratio a/b, is greater than a lower threshold value. This may lead to a sparse feature representation as discussed in the context of variational relevance vector machines, discussed further in Bishop et al., “Variational Relevance Vector Machines,” Proceedings of the 16^{th} Conference on Uncertainty in Artificial Intelligence, 2000, pp. 46-53.

Since the posteriors of the parameters w and v, i.e., θ, are conditionally independent of the hyper-parameter α, they can be computed separately from α. However, it may not be possible to compute them analytically. Accordingly, any suitable deterministic approximation framework may be defined to approximate the posterior of θ. For example, a Gaussian approximation of the posterior of θ may be analytically approximated in any suitable manner, such as with a Laplace approximation, variational inference (“VI”), and expectation propagation (“EP”). The Laplace approximation may be implemented using iterative re-weighted least squares (“IRLS”). Alternatively, a random Monte Carlo approximation may utilize sampling of p(θ).

Variational Inference

The variational inference framework may be based on maximization of a lower bound on the marginal likelihood. In defining the lower bound, both the parameters θ and hyper-parameters α may be assumed independent, such that the joint posterior distribution q(θ,α) over the variational parameters θ0 and the hyper-parameters α factorize to:
q(θ,α)=q(θ) q(α) (18)

Even with the factorization assumption of the joint posterior distribution q(θ,α), the pseudo-likelihood function F(θ) above must be further approximated. For example, the pseudo-likelihood function may be approximated by providing a determined bound on the logistic sigmoid. The pseudo-likelihood function F(θ), as shown above, is given as a product of sigmoidal functions. The sigmoidal function have a variational bound:
σ(z)≧σ(ξ)exp{(z−ξ)/2−λ(ξ)(z²−ξ²)} (19)
where ξ is a variational parameter indicating the contact point between the bound and the logistic sigmoid function when z=±ξ. The parameter λ(ξ) may be shown as:

$$λ ( ξ ) = \frac{1}{2 ξ} [ σ ( ξ ) - \frac{1}{2} ] \qquad ( 20 )$$

Accordingly, the sigmoidal function bound is an exponential of a quadratic function of θ, and may be combined with the Gaussian prior over θ to yield a Gaussian posterior. In this manner, the pseudo-likelihood function F(θ) may be bound by a pseudo-likelihood function bound £(θ, ξ):
F(θ)≧£(θ, ξ) (21)
where £(θ, ξ) is the bound for the pseudo-likelihood function and includes the sigmoid function bound substituted into the pseudo-likelihood bound equation of F(θ). In this manner, the bound £(θ, ξ) may be shown as:

$$£ ( θ , ξ ) = {\prod }_{n = 1 , i}^{N} σ ( {ξ}_{in} ) exp \{ ( {y}_{in} {θ}^{T} {ϕ}_{in} - {ξ}_{in} ) / 2 - λ ( {ξ}_{in} ) ( {{y}_{in}^{2} [ {θ}^{T} {ϕ}_{in} ]}^{2} - {ξ}_{in}^{2} ) \} \qquad ( 22 )$$

However, if the label y may take the value of either 1 or −1 such as in a two label system, then y²ᵢₙ=1, and may be removed from the above equation.

The bound £(θ, ξ) on the pseudo-likelihood function may then be used to construct a bound on the log of the marginal likelihood as:

$$ln p \text{(} Y \vert X ) \geq \int \int q ( θ ) q ( α ) ln \{ \frac{£ ( θ , ξ ) p ( θ \vert α ) p ( α )}{q ( θ ) q ( α )} \} ⅆ θ ⅆ α = L \qquad ( 23 )$$

The training model 202 of FIG. 2 may be developed by maximizing L with respect to the variational distributions q(θ) and q(α) as well as with respect to the variational parameters ξ. The optimization of with respect to q(θ) and q(α) may be free-form without restricting their functional form. To resolve the distribution q*(θ) which maximizes the bound L, the equation for L may be written as a function of q(θ) which may be a negative Kullback-Leibler (KL) divergence between q(θ) and the exponential of the integral of the natural log of £(θ,ξ)p(θ|α). Consequently, the natural log of the distribution q*(θ) which maximizes the bound may correspond to the zero KL divergence and may be a quadratic form in θ. In this manner, the distribution q*(θ) which maximizes the bound may be approximated with a Gaussian distribution which may be given as:
q*(θ)= [symbol] (θ|m,S) (24)
where [symbol] is a Gaussian distribution and the mean m may be given as:

$$m = S ( \frac{1}{2} {\sum }_{n = 1 , i}^{N} {ϕ}_{in} {y}_{in} ) \qquad ( 25 )$$

and where the covariance matrix S may be given as:

$${S}^{- 1} = 〈 D 〉 + 2 {\sum }_{n = 1 , i}^{N} λ ( {ξ}_{in} ) {ϕ}_{in} {ϕ}_{in}^{T} \qquad ( 26 )$$

Where [symbol] D [symbol] represents an expectation of the diagonal matrix made up of diag( [symbol] αᵢ [symbol] ), and φᵢₙ is the feature vector defined above. As shown by the equation for the inverse covariance matrix S⁻¹, the covariance matrix S may not be block-diagonal with respect to the concatenation θ=(w,v). Accordingly, the variational posterior distribution q*(θ) may capture correlations between the parameters w of the site association potentials and the parameters v of the interaction potentials.

To resolve the distribution q*(α) which maximizes the bound L, the equation for L may be written as a function of q(α). Consequently, the distribution q*(α), using a similar line of argument as with q*(θ) may be an independent Gamma distribution for each αᵢ. In this manner, an equation for the distribution q*(α) which maximizes the bound L may be given as:

$${q}^{*} ( α ) = {\prod }_{j = 1}^{M} G ( {α}_{i} \vert {a}_{j} , {b}_{j} ) \qquad ( 27 )$$

Where the parameter
aᵢ=a₀+½ (28)
and
bⱼ=b₀+½(mⱼ²+Sⱼⱼ) (29)
and where the expectation of θⱼ² is defined by:
θⱼ²=mⱼ²+Sⱼⱼ. (30)

To resolve the variational parameters ξ, the bound £(θ, ξ) may be optimized. In one example, the equation for the bound £(θ, ξ) may be rearranged keeping only terms with depend on ξ. Accordingly, the following quantity may be maximized,:

$${\sum }_{n = 1 , i}^{N} \{ ln σ ( {ξ}_{in} ) - {ξ}_{in} / 2 + λ ( {ξ}_{in} ) [ {ϕ}_{in}^{T} 〈 θ {θ}^{T} 〉 {ϕ}_{in} - {ξ}_{in}^{2} ] \} \qquad ( 31 )$$

To maximize the quantity of equation 31, the derivative of ξᵢₙ may be set equal to zero, and since λ′(ξᵢₙ) is not equal to zero, an equation for ξᵢₙ may be written:

$$\begin{matrix}{ξ}_{in}^{2} = {ϕ}_{in}^{T} [ m {m}^{T} + S ] {ϕ}_{in} & ( 32 ) \\ where 〈 θ {θ}^{T} 〉 = m {m}^{T} + S & ( 33 )\end{matrix}$$

In this manner, the equations for q*(θ), q*(α) and ξ may maximize the lower bound L. Since these equations are coupled, they may be solved by initializing two of the three quantities, and then cyclically updating them until convergence.

In one example, the lower bound L may be evaluated making use of standard results for the moments and entropies of the Gaussian and Gamma distributions of q*(θ) and q*(α), respectively. The computation of the bound L may be useful for monitoring convergence of the variational inference and may define a stopping criterion. The lower bound computation may help verify the correctness of a software implementation by checking that the bound does not decrease after a variational update, and may confirm that the corresponding numerical derivative of the bound in the direction of the updated quantity is zero.

The lower bound L may be computed by separating the lower bound equation for L into a sum of components C1, C2, C3, C4, and C5 where:
C1=∫q(θ) ln £(θ,ξ) dθ (34)
C2=∫∫q(θ)q(α) ln p(θ|α) dθdα (35)
C3=∫q(α) ln p(α) dα (36)
C4=−∫q(θ) ln q(θ) dθ (37)
C5=−∫q(α) ln q(α) dα (38)

Where q(θ) is the current posterior distribution for the parameters θ, q(α) is the current posterior distribution for the hyper-parameters α, and £(θ,ξ) is the bound for the pseudo-likelihood function F(θ) where ξ is the variational parameter.

By substituting the bound on the sigmoid function σ(z) given above into to the component C1, substituting the suitable expectations under the posterior q(θ) and the definition of λ(ξ), the first component C1 may be determined by:

$$C 1 = {\sum }_{n = 1 , i}^{N} ( ln σ ( {ξ}_{in} ) - \frac{1}{2} {ξ}_{in} + λ ( {ξ}_{in} ) {ξ}_{in}^{2} - λ ( {ξ}_{in} ) {ϕ}_{in}^{T} [ m {m}^{T} + S ] {ϕ}_{in} + \frac{1}{2} {y}_{in} m {ϕ}_{in} ) \qquad ( 39 )$$

To resolve the second component C2, the expectation of p(θ|α) may be determined with respect to q(θ) and q(α). By substituting in:

$$\begin{matrix}p ( α ) = {\prod }_{j = 1}^{M} G ( {α}_{j} \vert {a}_{0} , {b}_{0} ) & ( 40 ) \\ q ( α ) = {\prod }_{j = 1}^{M} G ( {α}_{j} \vert {a}_{N} , {b}_{N} ) and & ( 41 ) \\ p ( θ \vert α ) = ℵ ( {θ}_{j} \vert 0 , {α}_{j}^{- 1} ) & ( 42 )\end{matrix}$$

A result for the second component C2 may be given as:

$$C 2 = - \frac{M}{2} ln ( 2 π ) + \frac{1}{2} {\sum }_{j = 1}^{M} ( ( Δ ( {a}_{j} ) - ln {b}_{j} ) - \frac{{a}_{j}}{{b}_{j}} ( {m}_{j}^{2} + {S}_{jj} ) ) \qquad ( 43 )$$

Where Δ(a) is the di-gamma function defined by d|ln|Γ(a)/d|a.

The third component C3 may be resolved by taking the expectation of ln p(α) under the distribution of q(α) to give:

$$C 3 = M ( {a}_{0} ln {b}_{0} - ln Γ ( {a}_{0} ) ) + {\sum }_{m}^{M} ( ( {a}_{0} - 1 ) ( Δ ( {a}_{j} ) - ln {b}_{j} ) - {b}_{0} \frac{{a}_{j}}{{b}_{j}} ) \qquad ( 44 )$$

The fourth component C4 is the entropy term H_{q(θ)} of the distribution q(θ)=N(θ|μ,S) and making suitable substitutions; the fourth component may be given as:
C4=H_{q(θ)}=M/2 ln(2π)+M/2+½ln|S| (45)

The fifth component is the sum of the entropies for every distribution q(αⱼ) such that

$$C 5 = {H}_{q ( α )} = {\sum }_{j = 1}^{M} [ ln Γ ( {a}_{j} ) - ln {b}_{j} - ( {a}_{j} - 1 ) Δ ) {a}_{j} \text{)} + {a}_{j} \qquad ( 46 )$$

With reference to the variational inference training method 312 of FIG. 4, the parameters of variational inference of a Bayesian conditional random field may be initialized. More particularly, as shown in FIG. 4, the posterior distribution may be initialized 402. Specifically, the parameters may be initialized with a₀ and b₀ set to give a broad prior over α. Although any initialization values may be suitable for a₀ and b₀, these parameters may be initialized to 0.1 in one example. The posterior distribution for α may be initialized with its corresponding prior distribution. The prior distribution of α may be determined using the Gamma distribution noted in equation 17. Similarly, the posterior distribution of θ may be initialized with its corresponding prior distribution. The prior distribution of θ may be determined using the Gaussian distribution of equation 16 above. The feature vector φ may be initialized using equation 14. As shown in FIG. 4, the variational parameter ξ may be computed 404 using equation 32 above, assuming that the mean m and covariance S are the mean and covariance of the Gaussian distribution of θ, i.e., m=0 and S=diag( [symbol] αⱼ⁻¹ [symbol] ). The hyper-parameter vector [symbol] α [symbol] may be determined as the ratio of a₀/b₀, which may be a diagonal of 1 if a₀=b₀. The parameter vector λ(ξ) may be determined, using equations 20 and 6, the parameter vector λ(ξ) may be calculated.

Using the feature vector φ, the vector λ(ξ), and the [symbol] α [symbol] diagonal, the covariance S of the posterior q*(θ) may be computed 406, for example, using equation 26 above. Using the vector φ and computed covariance S, the mean m of the posterior q*(θ) may be computed 408, for example using equation 25 above. With the computed mean m and covariance S, the normal posterior q*(θ) is specified by the Gaussian of equation 24 above.

The shape and width of the posterior of the hyper-parameter α may be coputed 409. Specifically, parameter aⱼ may be updated with equation 28 above based on a₀. Parameter bⱼ may be updated with equation 29 above based on b₀ and the computed mean and covariance of the posterior of θ. With the updated parameters aⱼ, and bⱼ, the posterior of the parameter α (i.e., q*(α)) may be defined by the Gamma distribution of equation 27. The parameter ξ may be updated 410 using equation 32 based on the mean m, the covariance S, and the computed vector φ.

The lower bound L may be computed 412 by summing components C1, C2, C3, C4, and C5 as defined above in equations 39-46. The value of the lower bound may be compared to its value at the previous iteration to determine 414 if the training has converged. If the training has not converged, then the process may be repeated with computing the variational parameters ξ 404 based on the newly updated parameters until the lower bound has converged.

When the lower bound L has converged, the posterior probability of the labels given the newly observed data x to be labeled and the labeled training data (X,Y), (i.e., p(y|x,Y,X)) may be determined 416 to form the training model 212 of FIG. 2. In a Bayesian approach, the conditional posterior probability of the labels is determined by integrating over the posterior q*(θ). This may be approximated by the point-estimate m, i.e., the mean of the posterior probability q*(θ). This corresponds to the assumption that the posterior probability q*(θ) is sharply peaked around the mean m.

Expectation Propagation

Rather than using variational inference to approximate the posterior probabilities of the potential parameters w and v (i.e., θ), expectation propagation may be used. Under expectation propagation, the posterior is a product of components. If each of these components is approximated, an approximation of their product may be achieved, i.e., an approximation to the posterior probabilities of the potential parameters w and v. For example, the posterior probability of the potential parameters q*(v), may be approximated by:

$$q * ( v ) = ℵ ( v \vert 0 , diag ( β ) ) {\prod }_{i} {\prod }_{j} {\tilde{g}}_{ij} ( v ) \qquad ( 47 )$$

where [symbol] (−|m,S) is a probability density function of a Gaussian with mean m and covariance S; β is the modeling hyper-parameter vector associated with the interaction potential; and the approximation term \tilde{g}ᵢⱼ(v) may be parameterized by the parameters mᵢⱼ, ζᵢⱼ, and sᵢⱼ so that the approximate posterior q*(v) is a Gaussian, i:e.,:
q(v)≈ [symbol] (mᵥ,Sᵥ) (48)

The approximation term \tilde{g}ᵢⱼ(v) may be parameterized as:

$${\tilde{g}}_{ij} ( v ) = {s}_{ij} exp ( - {\frac{1}{{2 }_{{}_{ij}}} [ {y}_{i} {y}_{j} {μ}_{ij}^{T} ( x ) v - {m}_{ij} ]}^{2} ) \qquad ( 49 )$$

In this manner, expectation propagation may choose the approximation term \tilde{g}ᵢⱼ(v) such that the posterior q*(v) using the exact terms is close in KL divergence to the posterior using the approximation term \tilde{g}ᵢⱼ(v).

An example method 312 illustrating training of a posterior probability of the modeling potential parameters w and v using expectation propagation is shown in FIG. 5. The parameters may be initialized 502. Although any suitable initialization values may be used, the approximation term \tilde{g}ᵢⱼ(v) may be initialized to one, the first approximation parameter mᵢⱼ may be initialized to zero, the second approximation parameter ζᵢⱼ may be initialized to infinity, and the third approximation parameter sᵢⱼ may be initialized to 1. The posterior probability q*(v) may be initialized to be equal to the Gaussian approximation of the a priori probability of the potential parameters v, i.e., q*(v)=p(v), such that the mean mᵥ equals zero and the covariance Sᵥ equals the diagonal of the hyper-parameter β, which may be initialized to a vector with elements 100 Equation 49 for the approximation term \tilde{g}ᵢⱼ(v) may be iterated over all nodes i, and their pairwise nodes j as defined by the conditional random field graph until all the mᵢⱼ, ζᵢⱼ, and sᵢⱼ parameters converge. For example, the partition function may be assumed constant and the label posteriors may be computed as discussed further below. The marginal probabilities of the labels may be calculated, however, the MAP configuration may be used as discussed further below.

To iterate though the approximation term \tilde{g}ᵢⱼ(v), the approximation term \tilde{g}ᵢⱼ(v) may be removed from the equation for the posterior q*(v) to generate a ‘leave-one-out’ posterior q^{\ij}(v). The leave-one-out posterior q^{\ij}(v) may be Gaussian with a leave-one-out mean mᵥ^{\ij} and a leave-one-out covariance Sᵥ^{\ij}. Since q^{\ij}(v) is proportionate to q*(v)/\tilde{g}ᵢⱼ(v), then the leave-one-out mean mᵥ^{\ij} and a leave-one-out covariance Sᵥ^{\ij} may be implied as:

$${S}_{v}^{\backslash ij} = {S}_{v} + \frac{( {S}_{v} {y}_{i} {y}_{j} {μ}_{ij} ( x ) ) {( {S}_{v} {y}_{i} {y}_{j} {μ}_{ij} ( x ) )}^{T}}{{}_{ij} - {( {y}_{i} {y}_{j} {μ}_{ij} ( x ) )}^{T} {S}_{v} {y}_{i} {y}_{j} {μ}_{ij} ( x )} and \qquad ( 50 )$$

i mᵥ^{\ij}=mᵥ+Sᵥ^{\ij}yᵢyⱼμᵢⱼ(x)ζᵢⱼ⁻¹([yᵢyⱼμᵢⱼ(x)]^{T} mᵥ−mᵢⱼ) (51)

More particularly, with reference to FIG. 5, the covariance of the leave-one-out Sᵥ^{\ij} may be computed 506 using equation 50, and the leave-one-out mean mᵥ^{\ij} may be computed 508 using equation 51. With the above estimates of the leave-out parameters mᵥ^{\ij} and Sᵥ^{\ij}, the leave-one-out posterior q^{\ij}(v) may be determined as a Gaussian distribution of mean mᵥ^{\ij} and covariance of Sᵥ^{\ij}.

The leave-one-out posterior may be combined with the exact term gᵢⱼ(v)=I(yᵢ,yⱼ,v,x) (to determine an approximate posterior \hat{p}(v) which is proportionate to gᵢⱼ(v)q^{\ij}(v).

In this manner, the posterior q*(v) may be chosen to minimize the KL distance KL (\hat{p}(v)||q*(v), which may be determined by moment matching as follows. The following parameter equations may be used to update the approximation term \tilde{g}ᵢⱼ(v):

$$\begin{matrix}{m}_{v} = {m}_{v}^{\backslash ij} + {S}_{v}^{\backslash ij} {ρ}_{ij} {y}_{i} {y}_{j} {μ}_{ij} ( x ) & ( 52 ) \\ {S}_{v} = {S}_{v}^{\backslash ij} - ( {S}_{v}^{\backslash ij} ) [ {y}_{i} {y}_{j} {μ}_{ij} ( x ) ] ( \frac{{ρ}_{ij} ( {[ {y}_{i} {y}_{j} {μ}_{ij} ( x ) ]}^{T} {m}_{v} + {ρ}_{ij} τ )}{{[ {y}_{i} {y}_{j} {μ}_{ij} ( x ) ]}^{T} {S}_{v}^{\backslash ij} [ {y}_{i} {y}_{j} {μ}_{ij} ( x ) ] + τ} ) {( {S}_{v}^{\backslash ij} ) [ {y}_{i} {y}_{j} {μ}_{ij} ( x ) ]}^{T} & ( 53 ) \\ {Z}_{ij} = {\int }_{v}^{} {g}_{ij} ( v ) {q}^{\backslash ij} ( v ) ⅆ v & ( 54 ) \\ = ɛ + ( 1 - 2 ɛ ) {Ψ}_{1} ( {z}_{ij} ) & ( 55 )\end{matrix}$$

where τ is the covariance used in the probit function used in the potential (i.e., cumulative distribution for a Gaussian with mean zero and variance of τ²), Ψ₁, is a probit function based on a Gaussian with mean zero and variance of 1, and Zᵢⱼ is a normalizing factor with normalizing parameters zᵢⱼ and ρᵢⱼ, which may be determined as:

$$\begin{matrix}{z}_{ij} = \frac{{( {m}_{v}^{\backslash ij} )}^{T} [ {y}_{i} {y}_{j} {μ}_{ij} ( x ) ]}{\sqrt{{[ {y}_{i} {y}_{j} {μ}_{ij} ( x ) ]}^{T} {S}_{v}^{\backslash ij} [ {y}_{i} {y}_{j} {μ}_{ij} ( x ) ] + τ}} and & ( 56 ) \\ {ρ}_{ij} = \frac{1}{\sqrt{{[ {y}_{i} {y}_{j} {μ}_{ij} ( x ) ]}^{T} {S}_{v}^{\backslash ij} [ {y}_{i} {y}_{j} {μ}_{ij} ( x ) ] + τ}} \frac{( 1 - 2 ɛ ) ℵ ( {z}_{ij} ; 0 , 1 )}{( 1 - 2 ɛ ) ɛ + ( 1 - 2 ɛ ) {Ψ}_{1} ( {z}_{ij} )} & ( 57 )\end{matrix}$$

With reference to FIG. 5, the mean mᵥ of the posterior distribution of the parameter vector v may be computed 510 using equations 52-53 and 56-57. Similarly, the covariance Sᵥ of the posterior distribution of the parameter vector v may be computed 512 using equations 53 and 56-57. In this manner, the posterior distribution of the parameter vector v (i.e., q*(v)) may be defined as a Gaussian having mean mᵥ and covariance Sᵥ.

From the normalizing factor Zᵢⱼ, the term approximation \tilde{g}ᵢⱼ(v) may be updated using:

$$\begin{matrix}{\tilde{g}}_{ij} ( v ) = {Z}_{ij} \frac{q ( v )}{{q}^{\backslash i , j} ( v )} & ( 58 ) \\ {}_{ij} = {[ {y}_{i} {y}_{j} {μ}_{ij} ( x ) ]}^{T} {S}_{v}^{\backslash ij} [ {y}_{i} {y}_{j} {μ}_{ij} ( x ) ] ( \frac{1}{{ρ}_{ij} ( {[ {y}_{i} {y}_{j} {μ}_{ij} ( x ) ]}^{T} {m}_{v} + {ρ}_{ij} τ )} - 1 ) + \frac{τ}{{{ρ}_{ij} [ {y}_{i} {y}_{j} {μ}_{ij} ( x ) ]}^{T} {m}_{v} + {ρ}_{ij} τ} & ( 59 ) \\ {m}_{ij} = {[ {y}_{i} {y}_{j} {μ}_{ij} ( x ) ]}^{T} {m}_{v}^{\backslash ij} + ( {}_{ij} + {[ {y}_{i} {y}_{j} {μ}_{ij} ( x ) ]}^{T} {S}_{v}^{\backslash ij} [ {y}_{i} {y}_{j} {μ}_{ij} ( x ) ] ) {ρ}_{ij} & ( 60 )\end{matrix}$$

As noted above, the hyper-parameters α (discussed further below) and β of the expectation propagation method may be automatically tuned using automatic relevance determination (ARD). ARD may de-emphasize irrelevant features and/or emphasize relevant features of the fragments of the image data. In one example, ARD may be implemented by incorporating expectation propagation into an expectation maximization algorithm to maximize the model marginal probability p(α|y) and p(β|y).

To update the hyper-parameter β, a similar expectation maximization such as that described by Mackay, D. J., “Bayesian Interpolation,” Neural Computation, vol. 4, no. 3, 1992, pp. 415-447. For example, the hyper-parameter β may be updated using:

$${β}_{j}^{new} = \frac{1}{{( {S}_{v} )}_{jj} + {( {m}_{v} )}_{j}^{2}} \qquad ( 61 )$$

where Sᵥ amd mᵥ may be obtained from expectation propagation of equations 52 and 53 respectively. The other hyper-parameter α may be updated similarly. Moreover, this EP-ARD approach may be viewed as an approximate full Bayesian treatment for a hierarchical model where prior distributions on the hyper-parameters α, β may be assigned. In this manner, the number of potential parameters w, v, are selected from the available features.

With reference to FIG. 5, the parameters may be updated 514. More particularly, the term approximation \tilde{g}ᵢⱼ(v) may be updated using equations 58 with 55-56. The hyper parameters β may be updated using equation 61. The parameters mᵢⱼ and ζᵢⱼ may be updated using equations 59 and 60 respectively. The normalization sᵢⱼ may not be computed since the mean and covariance of g(v) do not depend on sᵢⱼ. The updated parameters mᵢⱼ, ζᵢⱼ, and sᵢⱼ may be compared 516 to the respective prior parameters. If their difference is greater than a predetermined threshold, i.e., not converged, then the method may be repeated by repeating the steps of FIG. 5 starting at computing 506 the leave-one-out covariance.

When the term approximation parameters mᵢⱼ, ζᵢⱼ, and sᵢⱼ converge, the posterior probability q*(v) may be determined as a Gaussian having mean mᵥ and covariance of Sᵥ.

The posterior of the association potential parameters q*(w) may be determined in a manner similar to that described above for the posterior of the interaction potential parameters q*(v). More particularly, to resolve q(w), the site potential A may be used in lieu of the interaction potential I, and the hyper-parameter a used in lieu of the hyper-parameter β. Moreover, the label yᵢ may be used in lieu of the product yᵢyⱼ, and the site feature vector hᵢ(x) may be used in lieu of the interaction feature vector μᵢⱼ(x).

The determination of the posteriors q*(w) and q*(v) may be used to form the training model 206 of FIG. 2

Prediction Labeling

With reference to FIGS. 2 and 3, the labeling system 200 may receive test data 212 to be labeled. Similar to the training data, the test data 212 may be received 302, such as by the label predictor 222. The test data may be formatted and/or modified as appropriate for use by the label predictor. For example, a drawing may be digitized.

The test data 212 may be fragmented 304 using any suitable method, which may be application specific. Based upon the fragments of each test image, a neighborhood, undirected graph for each image maybe constructed 306 using any suitable method.

One or more site features of each node of the test data 212 may be computed 308, using the hᵢ vector function developed in the training of the training model. One or more interaction features of each connection edge of the graph between pairwise nodes of the test data 212 may be computed 310 using the interaction function μᵢⱼ developed in the training of the training model. The training model 206 may be used by the label predictor to determine a probability distribution of labels 214 for each fragment of each image in the test data 212. An example method of use 314 of the developed training model to generate a probability distribution of the labels for each fragment is shown in FIG. 6, discussed further below.

The development of the posterior distribution q*(θ) of the potential parameters w, v through the Bayesian training with variational inference done with the training set image data allows predictions of the labels y to be calculated for a new observations (test data) x. For this, the predictive distribution may be given by:
p(y|x,Y,X)=∫p(y|x,θ)q(θ) dθ (62)
where X is the observed training data of the training images 202, Y is the training labels 204, x is the observed test data 212 or other data to be labeled with the available test data labels 214 (y), as shown in FIG. 2.

As noted above, the predictive distribution may be approximated by assuming that the posterior is sharply peaked around the mean and to approximate the predictive distribution using:
p(y|x,Y,X)≈p(y|x,m) (63)
where m is the mean of the Gaussian variational posterior q*(θ).

With reference to FIGS. 2 and 6, the initial test data labels y may be computed 606. In one example, the initial prediction of the labels may be based on the nodal or site features h(x) and the corresponding part of the mean m. More particularly, equation 3 may be truncated to exclude consideration of the interaction potential I (i.e., consider the site potential A).

Since the partition function Z may be intractable due to the number of terms, the association potential portion of the marginal probability of the labels (i.e., equation 2) may be approximated. In one example, equation 15 for the marginal probability may be truncated to remove consideration of the interaction potential by removing one of the products and limiting φᵢₙ to the site feature portion (i.e., φᵢₙ=hᵢ(x)). In this manner, the marginal probability of the labels may be approximated as:

$$p ( y \vert x , w ) = {\prod }_{i} σ ( {y}_{i} {w}^{T} {ϕ}_{i} ) \qquad ( 64 )$$

With reference to FIG. 6, the marginal probabilities of a node label y may be computed 608 using equation 64.

Given a model of the posterior distribution p(y|x,Y,X) as p(y|x,w), the most likely label ŷ may be determined as a specific solution for the set of y labels. In one approach, the most probable value of y (ŷ) may be represented as:
ŷ=arg max_{y} p(y|x,Y,X) (65)

In one implementation of the most probable value of y (ŷ), an optimum value may be determined exactly if there are few fragments in each test image, since the number of possible labelings may equal 2^{N} where N is the number of elements in y, i.e., the number of nodes.

When the number of nodes N is large, the optimal labelings may be approximated by finding local optimal labelings, i.e., labelings where switching any single label in the label vector y may result in an overall labeling which is less likely. In one example, a local optimum may be found using iterated conditional modes (ICM), such as those described further in Besag, J. “On the Statistical Analysis of Dirty Picture,” Journal of the Royal Statistical Society, B-48, 1986, pp. 259-302. In this manner, ŷ may be initialized and the sites or nodes may be cycled through replacing each ŷᵢ with:
yᵢ←arg max_{yi} p(yᵢ|y_{Ni},x,Y,X) (66)

More particularly, as shown in FIG. 6, each node may be labeled 606 choosing the most likely label ŷ based on the computed distribution. The initial distribution p(yᵢ|y_{Ni},x,Y,X) may be determined with equation 64. Since equation 64 does not include interaction between the elements of y, it takes N steps to determining the most likely labels, i.e., one for each node. With the most likely labels ŷ, a new marginal probability p(yⱼ|y_{Ni},x,Y,X) may be computed 608 based on both the site association potentials A and the interaction potentials I. In one example, the new marginalized probability p(yⱼ|y_{Ni},x,Y,X) may be computed as indicated in equation 66 using:
p(yⱼ|y_{Ni},x,w,v)∝exp(yⱼm^{T}φⱼ/2) (67)
where φⱼ is defined by equation 14.

The most likely labels ŷ be computed and selected 610 from the new marginalized probability, and compared 612 with the previous most likely label. If the label has not converged, then the new marginal probability may be computed 608, and the method repeated until the labels converge. More particularly, as each label changes, the marginal probability will change until the labels converge on the local maximum of the labels. When the labels converge, the trained labels may be provided 614. More particularly, the marginal probability over the label of a single ode may be determined using equation 67. However, ICM provides the most likely labels, not the marginal joint probability over all the labels. The marginal joint probability over all the labels may be provided using, for example, expectation propagation.

In other approaches, a global maximum of ŷ may be determined using graph cuts such as those described further in Kolmogorov et al., “What Energy Function Can be Minimized Via Graph Cuts?,” IEEE Transactions on Pattern Analysis and Machine Intelligence, 26(2), 2004, pp. 147-159. In some cases, the global maximum using graph cuts may require that the interaction term be artificially constrained to be positive.

In an alternative example, the maximum probable value of the predicted labels ŷ may be determined 606 by introducing a loss function L(ŷ,y). More particularly, the loss function may allow weighting of different status of the labels. For example, the user may care more about misclassifying nodes from calls yᵢ=+1 than misclassifying nodes where yᵢ=−1. More particularly, the user may desire that fragments or nodes be properly identified, especially if the true label of that fragment is a particular label, i.e., man-made. To formalize the notion of label classification, the label vector ŷ may be chosen 606 and the loss incurred by choosing that ŷ when the true label vector is y may be denoted by the loss function L(ŷ,y). The loss may be minimized in any suitable manner, however, if the true labels are unknown (as it is with label prediction), then the expected loss may be minimized under the posterior distribution of the labels p(y|x,Y,X). The expected loss under the posterior distribution G(ŷ) may be given as:

$$G \text{(} \hat{y} ) = {E}_{y} [ L ( \hat{y} , y ) ] = {\sum }_{y} L ( \hat{y} , y ) p ( y \vert x , Y , X ) \qquad ( 68 )$$

Where the loss function L(ŷ,y) may be given by:
L(ŷ,y)=l(y)(1−δ_{ŷ,y}) (69)

Where δ_{ŷ,y} is one if the label is chosen correctly (i.e., ŷ=y), and is zero if the label is chosen incorrectly. The function l(y) may be determined as:
l(y)=Σ η^{(1-yi)/2}(1−η)^{(1+yi)/2} (70)
with η constrained to be 0≦η≦1. For η=0, the minimum expected loss may occur when all states are classified as ŷᵢ=−1, and for η=1, the minimum expected loss may occur when all states are classified as ŷᵢ=+1. For η=½, the minimum expected loss may be obtained by choosing the most probable label vector defined by ŷ=arg max_{y} p(y|x,Y,X). If η is allowed to vary between 0 and 1, a curve, such as a receiver operator characteristic (ROC) curve may be swept out to show the detection rate versus the false positive rate. For those models where it is applicable (i.e. those having a positive interaction term) the graph cut algorithm may be appropriately applied to obtain the ROC curve by scaling the likelihood function using the equation given above for l(y).

After the labels yᵢ are initialized 606 based on the site association potential as shown in FIG. 6, the expected loss may be given by G(ŷ) as defined in equation 6768 which may be minimized by iteratively optimizing the yᵢ, corresponding to the technique of iterated conditional modes (ICM) shown in FIG. 6. A simple modification of the ICM algorithm of equation 66 may be shown as:
yᵢ←arg max_{yi} {η^{(1-yi)/2}(1−η)^{(1+yi)/2}p(yᵢ|y_{N},x,Y,X)} (71)
by substituting equation 69 for L(ŷ,y) into equation 68 for the expected loss G(ŷ) and noting that some terms are independent of ŷ.

In some cases, it may be appropriate to minimize the number of misclassified nodes. To minimize the number of misclassified nodes, the marginal probability at each site rather than the joint probability over all sites may be maximized. The marginalizations may be intractable; however, any suitable approximation may be used such as by first running loopy belief propagation in order to obtain an approximation to the site marginals. In this manner, each site may select the value with the largest weighted posterior probability where the weighting factor is given by η for yᵢ=1 and 1−η for yᵢ=−1.

Although the above examples are described with reference to a two label system (i.e., yᵢ=±1), the expansion to greater than two classes may allow the interaction energy to depend on all possible combinations of the class labels at adjacent sites i and j. A simpler model, however, may depend on whether the two class labels of nodes i and j were the same or different. An analogous model may then be built as described above and based on the softwax non-linearity instead of the logistic sigmoid. While no rigorous bound on the softmax function may be known to exist, a Gaussian approximation to the softmax may be conjectured as a bound, such as that described in Gibbs, M. N., “Bayesian Gaussian Processes for Regression and Classification,” Ph. D. thesis, University of Cambridge, 1997. The Gaussian bound may be used to develop a tractable variational inference algorithm. The generalization of Laplace's method and expectation propagation to the multi-class softmax case may be tractable.

In another example, the maximum a posteriori (MAP) configuration of the labels Y in the conditional random field defined by the test image data X may be determined with a modified max-product algorithm so that the potentials are conditioned on the test data X.

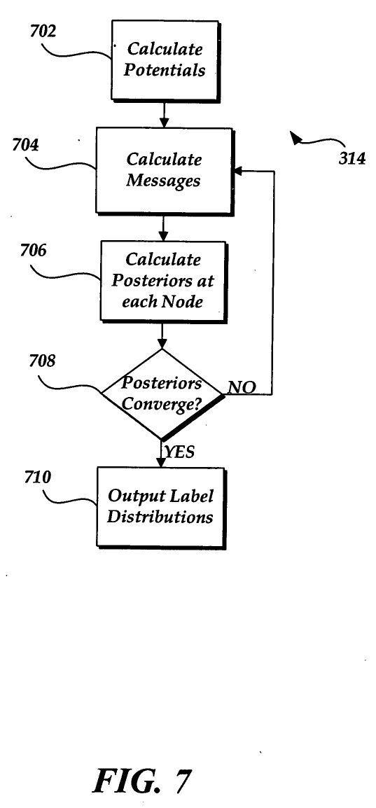

The update rules for a max-product algorithm may be denoted as:

$$\begin{matrix}{ω}_{ij} ( {y}_{j} ) ∝ {max}_{{y}_{i}} I ( {y}_{i} , {y}_{j} , x ; v ) A ( {y}_{i} , X ; w ) {\prod }_{k ∈ ℵ ( i ) \backslash j} {ω}_{ki} ( {y}_{i} ) & ( 72 ) \\ {q}_{i} ( {y}_{i} ) ∝ A ( {y}_{i} , x ; w ) {\prod }_{k ∈ ℵ ( i )} {ω}_{ki} ( {y}_{i} ) & ( 73 )\end{matrix}$$

where ωᵢⱼ(yⱼ) indicates the message that node i sends to node j and qᵢ(yᵢ) indicates the posterior at node i. With reference to the method 314 of using the training method of FIG. 7, the association potential A and interaction potential I may be calculated 702 based on the mean mᵥ and m_{w} of the parameter distributions determined in the training model 206 of FIG. 2. More particularly, equation 8 may be used to calculate the site association potential A and equation 9 may be used to calculate the interaction potential I.

The messages sent along an edge from node i to node j may be calculated 704 using equation 72. More particularly, an edge i,j may be chosen and the potential over all of its values may be computed. The message along the edge from node i to its neighboring node j may then be sent. The next edge may be chosen and the cycle repeated.

When all cliques have their respective messages computed, the belief of each node may be calculated 706. The belief at each node may be calculated using equation 73. Equation 73 explicitly recites the site potential A, and the interaction potential I is imbedded in ω. The newly computed beliefs may be compared to the previous beliefs of the nodes to determine 708 if they have converged. If the beliefs has not converged, then the messages between neighboring nodes may be re-computed 704, and the method repeated until convergence. At convergence, the probability distribution of each node from step 706 may be output as the label distributions for each node 214 of FIG. 2

In an alternative example, the max-product algorithm may be run on an undirected graph which has been converted into a junction tree through triangulation. Thus, with reference to FIG. 3, constructing 306 the neighborhood graph may include triangulating the graph and converting the undirected graph to a junction tree in any suitable manner, such as that described by Madsen, et al, “Lazy Population in Junction Trees,” Procedures of UAI, 1998, which is incorporated herein by reference. More particularly, a junction tree may be constructed over the cliques of the triangulated graph, i.e., each node in a junction tree may be a clique, i.e., a set of fully connected nodes of the original undirected graph. The undirected graph modified as a junction tree may be used in conjunction with a modified max-product algorithm to achieve the global optimal MAP solution and which may avoid the potential divergence. To do so, a clique potential Θ_{c}(y_{c}, x; v, w) may be calculated for each clique c in the junction tree, where y_{c} are the labels of all nodes the clique. In one example, the clique potential may be calculated by multiplying all association potentials for nodes in the clique c, and also multiplying by all interaction potentials for edges incident on at least one node in c, but ensuring that each interaction potential is only multiplied into one clique (thus omitting interaction potentials that have already been multiplied into another clique). Using the update equations 72 and 73, the interaction and association potentials may be replaced by the clique potential, and the message may now be sent between two cliques connected in the junction tree (instead of between individual nodes connected by edges).

For example, a clique in the junction tree may be chosen and the message to one of its neighbors may be calculated. The next clique may the be chosen, and the method repeated, until each clique has sent a message to each of its neighbors.

When all cliques have their messages computed, the belief of each node may be calculated 706 using, for example, equation 73 where for junction trees, the potentials are over cliques of nodes rather than individual nodes. The beliefs may be compared with the beliefs of a previous iteration to determine 708 if the beliefs have converged. If the beliefs have not converged, then the messages between neighboring cliques may be re-computed 704, and the method repeated until convergence. At convergence, the probability distribution of each node from step 706 may be output as the label distribution 2124 of FIG. 2.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method comprising:
a) forming a neighborhood graph from a plurality nodes, each node representing a fragment of a training image;
b) determining site features for each node;
c) determining interaction features of each node; and
d) determining a posterior distribution of a set of modeling parameters based on the site features, the interaction features, and a label for each node.

2. The method of claim 1, further comprising automatically determining the relevance of at least one of the site features and the interaction features.

3. The method of claim 1, wherein the modeling parameters include a site modeling parameter, an interaction modeling parameter, and a hyper-parameter.

4. The method of claim 1, wherein determining the posterior distribution includes determining a mean and covariance of a Gaussian distribution of at least one of the modeling parameters θ.

5. The method of claim 1, wherein determining the posterior distribution includes determining a shape and scale of a Gamma distribution of at least one of the modeling parameters α.

6. The method of claim 1, wherein the posterior distribution maximizes a pseudo-likelihood lower bound.

7. The method of claim 6, wherein the posterior distribution is determined when the lower bound is converged.

8. The method of claim 1, wherein the label for each node is selected from a group consisting of a first label and a second label.

9. The method of claim 1, wherein the posterior distribution of the modeling parameters includes a first distribution and a second distribution, wherein the first and second distributions are assumed independent.

10. The method of claim 1, wherein determining the posterior distribution includes approximating the posterior distributions with variational inference.

11. The method of claim 1, wherein determining the posterior distribution includes approximating the posterior distribution with expectation propagation.

12. The method of claim 11, wherein determining the posterior distribution includes determining an approximation term such that the posterior distribution is an approximation that is close in KL divergence to an actual posterior distribution.

13. The method of claim 12, wherein determining the approximation term includes determining a leave one out mean and a leave one out covariance, the leave one out mean and leave one out covariance being associated with a leave one out posterior distribution of the parameters based on the posterior distribution of the parameters with the approximation term removed.

14. The method of claim 13, wherein determining the approximation term includes determining a mean and a covariance of the posterior distribution of the modeling parameters based on reducing a KL distance through moment matching.

15. The method of claim 1, further comprising triangulating the neighborhood graph.

16. The method of claim 1, further comprising determining a training model providing a distribution of the labels given a set of observed data.

17. The method of claim 16, wherein the distribution of labels is sharply peaked around a mean of the posterior distribution of the set of modeling parameters.

18. The method of claim 16, further comprising predicting a distribution of labels for a fragment of an observed image based on the training model.

19. The method of claim 18, wherein predicting includes locating a local optimum of labels for the fragment of the observed image.

20. The method of claim 19, wherein locating includes using iterated conditional modes.

21. The method of claim 18, wherein predicting includes determining a global maximum of the labels for the fragment of the observed data using graph cuts.

22. The method of claim 18, wherein predicting includes determining a maximum probable value of the label for the fragment of the observed image using a loss function.

23. The method of claim 18, wherein predicting includes minimizing misclassification of the fragment of the observed image.

24. The method of claim 18, wherein predicting includes locating a global maximum of labels for the fragment of the observed data using maximum a posteriori algorithms.

25. The method of claim 1, wherein determining a posterior distribution of the set of modeling parameters includes determining a site association potential of each node and an interaction potential between connected nodes.

26. The method of claim 25, wherein determining the site association potential includes estimating noise of the labels with a labeling error rate variable.

27. The method of claim 25, wherein determining the interaction potential includes estimating noise of the labels with a labeling error rate variable.

28. One or more computer readable media containing executable instructions that, when implemented, perform a method comprising:
a) receiving a training image and a set of training labels associated with fragments of the training image;
b) forming a conditional random field over the fragments;
c) forming a set of Bayesian modeling parameters;
d) training a posterior distribution of the Bayesian modeling parameters;
e) forming a training model based on the posterior distribution of the Bayesian modeling parameters.

29. The one or more computer readable media of claim 28, wherein the Bayesian modeling parameters includes a site association parameters and an interaction parameter.

30. The one or more computer readable media of claim 29, wherein the method further comprises determining a site feature of each fragment and an interaction feature based on at leas two fragments.

31. The one or more computer readable media of claim 29, wherein training includes assuming that at least two of the Bayesian modeling parameters are independent.

32. The one or more computer readable media of claim 31, wherein training includes making a pseudo-likelihood approximation of the posterior distribution of the Bayesian modeling parameters.

33. The one or more computer readable media of claim 29, wherein training includes using variational inference algorithms.

34. The one or more computer readable media of claim 29, wherein training includes using expectation propagation algorithms.

35. The one or more computer readable media of claim 28, wherein the method further comprises predicting a distribution of labels of a fragment of an observed image.

36. A system for predicting a distribution of labels for a fragment of an observed image comprising:
a) a database that stores media objects upon which queries can be executed;
b) a memory in which machine instructions are stored; and
c) a processor that is coupled to the database and the memory, the processor executing the machine instructions to carry out a plurality of functions, comprising:
i) receiving a plurality of training images;
ii) fragmenting the plurality of training images to form a plurality of fragments;
iii) receiving a plurality of training labels, a label being associated with each fragment;
iv) forming a neighborhood graph comprising a plurality of nodes and at least one edge connecting at least two nodes, wherein each node represents a fragment;
v) for each node, determining a site feature;
vi) for each edge, determining an interaction feature;
vii) approximating a posterior distribution of a site Bayesian modeling parameter based on the site feature; and
viii) approximating a posterior distribution of an interaction Bayesian modeling parameter based on the interaction feature.

37. The system of claim 36, wherein the functions further comprise predicting a distribution of labels for a fragment of a test image based on the posterior distribution of the site Bayesian modeling parameter and the posterior distribution of the interaction Bayesian modeling parameter.

38. The system of claim 36, wherein approximating the posterior distribution of the interaction Bayesian modeling parameter includes using variational inference algorithms.

39. The system of claim 36, wherein approximating the posterior distribution of the interaction Bayesian modeling parameter includes using expectation propagation.

40. One or more computer readable media containing executable components comprising:
a) means for determining a posterior distribution of Bayesian modeling parameters based on received training images and received training labels associated with the training images; and
b) means for predicting a distribution of labels for a received test image based on the posterior distribution of Bayesian modeling parameters.

41. The one or more computer readable media of claim 37, wherein the means for determining includes means for approximating the posterior distribution of Bayesian modeling parameters using variational inference.

42. The one or more computer readable media of claim 37, wherein the means for determining includes means for approximating the posterior distribution of Bayesian modeling parameters using expectation propagation.
